(19) United States
(12) Patent Application Publication
(10) Pub. No.: US 2005/0229790 A1
(43) Pub. Date: Oct. 20, 2005

(54) Apparatus for cooking toast

(76) Inventor: Giuseppe De'Longhi, Treviso (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/516,523

(22) PCT Filed: Feb. 17, 2003
(86) PCT No.: PCT/EP03/01559

§ 371 Date: Nov. 30, 2004

(30) Foreign Application Priority Data
May 31, 2002 (IT) MI2002A001188

(51) Int. Cl. A47J 37/08

(52) U.S. Cl. 99/389

(57) ABSTRACT

The apparatus for cooking toast (1) has a body with an outer casing (2) made from metal material inside of which there is a plurality of radiating elements (3) managed by a control device and arranged near to the cooking chamber (10) the access to which is defined by one or more load openings (7) in the outer casing (2) made from metal material. The apparatus comprising means (5) for cooling the surfaces of the outer casing (2).

The present finding refers to an apparatus for cooking toast or toaster.

As is known, for reasons of cleaning, strength and aesthetics, some of the current toasters are realised with a metal, generally chromed casing, inside of which there are a plurality of quartz radiating elements or ones with wire resistances, which are normally managed by a control device activated by the user of the toaster.

The radiating elements are arranged near to the toast-cooking chamber the access to which is defined by two load openings on the top of the metal outer casing.

The metal side walls on the outside of the toaster, whilst it is being switched on, heat up substantially by radiation reaching high temperatures from the first toasting: greater than 60° C.

The upper metal parts of the casing where there are the two load openings also heat up by radiation and also by convection of the hot air which comes out from them.

At the end of the first toasting, these upper parts of the casing reach very high temperatures, greater than 150° C. in the central zone, with the risk of causing burns to the user who accidentally places a hand in direct contact with such parts.

In toasters of the known type, in a first embodiment, the heat by radiation is generated by the radiating elements with wire resistances, which are mounted on thin mica panels and which have a power density which increases from top to bottom, i.e. towards the inside of the toaster, since the high parts of toast are heated by the heat coming from the lowest layers.

In the same way, in a second embodiment the heat is generated by quartz radiating elements associated with reflective parabolas which are directed so that the infra-red radiation better reaches the lower layers of the toast.

The control device of toasters, of the known type, is normally cooled by means of the “chimney effect” caused by the flow of hot air which flows from bottom to top, periodically bringing in fresh air from the base of the domestic appliance.

As a consequence to the above, it should be noted that toasters with a metal casing have, amongst other drawbacks, that of having the surfaces hot to such a point as to be able to burn the user both during use and immediately afterwards. Moreover, all of the heat combines to heat the upper part of the apparatus.

The task proposed of the present finding is that of eliminating the aforementioned drawbacks of known toasters with a metal casing.

In this task, an important purpose of the finding is to realise an apparatus for cooking toast, or toaster, which, whilst still having a power which is equal to or less than toaster of the known type, keeps its outer metal walls at an extremely low temperature or at least a temperature lower than that which could give the user the sensation of being burnt.

Yet another purpose of the finding is to realise an apparatus for cooking toast which also allows the optimal cooking of filled sandwiches (or of individual slices of toasted bread) which need higher temperatures required for cooking ham and melting cheese contained in the toast since all of the heat goes to heat the upper part of the apparatus.

A further purpose of the finding is to realise an apparatus for cooking toast which can use the heat generated for second uses, such as that of heating food outside of the toaster.

The last but not least purpose of the finding is that of realising an apparatus for cooking toast which has an extremely robust body being made from metal, which is easy to clean and which does not have a flow of hot air coming out from its top part, but rather from a side portion thereof.

This task, as well as these and other purposes, are achieved by an apparatus for cooking toast having a body with an outer casing made from metal material inside of which there is a plurality of radiating elements managed by a control device and arranged near to the cooking chamber the access to which is defined by one or more load openings in said outer casing made from metal material, characterised in that it comprises means for cooling the surfaces of said outer casing.

Further characteristics and advantages of the invention shall become clearer from the description of a preferred, but not exclusive, embodiment of the apparatus for cooking toast according to the finding, illustrated for indicating and not limiting purposes in the attached drawings, in which:

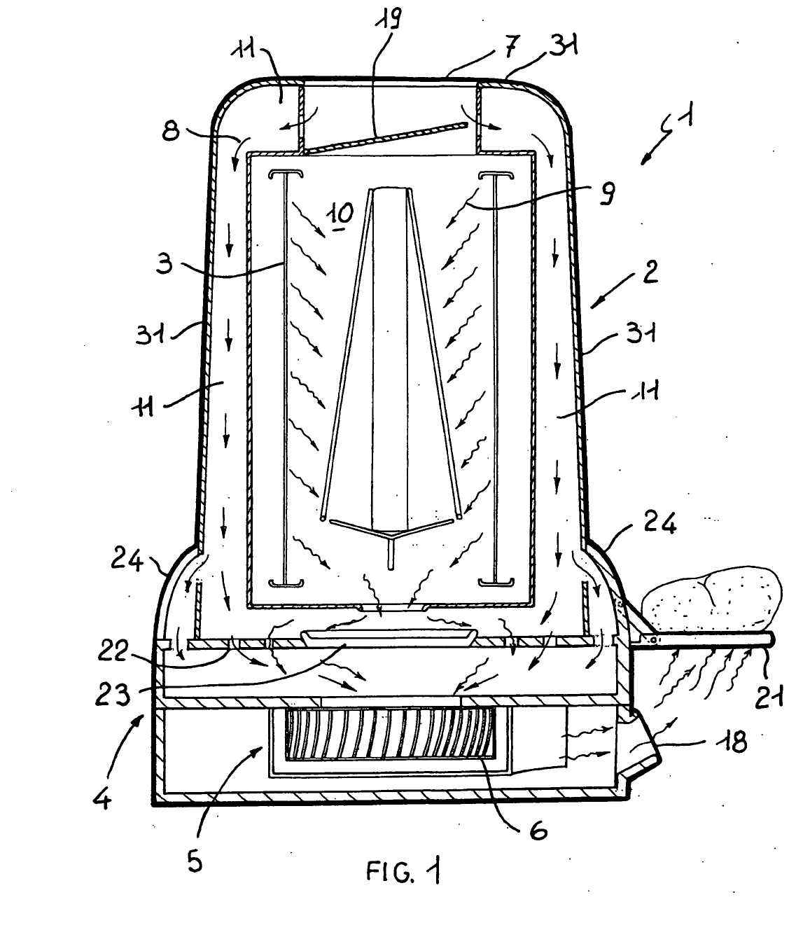

FIG. 1 is a cross-section side view of the apparatus for cooking toast according to the finding; and

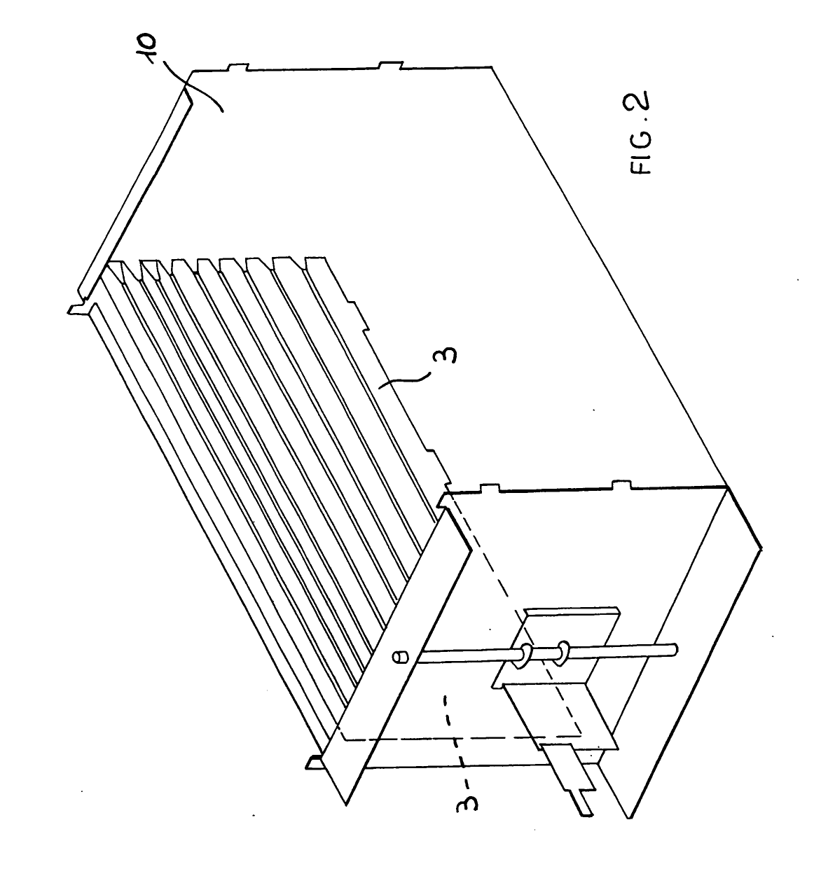

FIG. 2 is a partial schematic view of one of the radiating elements according to the finding in which its is seen that they are thicker at the top and thinner at the bottom.

With reference to the figures described above, the apparatus for cooking toast, or toaster, according to the finding, wholly indicated with reference numeral 1, comprises a body with an outer casing made from metal material, generically indicated with 2, inside of which there is a plurality of radiating elements, for example quartz radiating elements or ones with a wire resistance, indicated with 3.

The radiating elements 3 are managed by a control device, not represented, arranged at the bottom of the casing 2, inside a base made from plastic material generically indicated with 4. The radiating elements 3 are arranged near to the cooking chamber 10 for the toast, the access to which is defined by two load openings on the top of the casing 2.

Advantageously, the toaster has cooling means, wholly indicated with 5, for the surfaces of the outer casing 2.

In particular, the cooling means 5 comprises a ventilation member and more precisely a radial ventilator 6, housed in the base 4 and suitable for generating a current of air which is sucked through the upper load opening 7 and is expelled at the side and at the bottom of the body, and in particular from the base 4 through the discharge openings 18.

More specifically, the current of air has a first flow of cold air 8 which is sucked by the load opening 7 and a second flow of hot air 9 which is sucked by the cooking chamber 10. The first flow of cold air passes mainly in perimetric ducts 11 realised inside the casing 2, whereas the second flow of hot air 9 passes mainly inside the cooking chamber 10 and mixes with the first flow of cold air 8 at the bottom of the casing 2, upstream of the radial ventilator 6.

The control device, which has not been represented in the drawings, cannot be housed in a suitable zone of the toaster and, preferably, is housed inside the base 4. Therefore, it is constantly cooled by the first flow of cold air 8.

Suitably, the first and second flow of air 8 and 9 are substantially kept separate from each other at least along the whole length of the casing 2, so that the side, front and upper outer walls 31 have a low temperature and thus do not feel hot to the user when he touches them.

The wire radiating elements 3 suitably have a power density which decreases towards the base of the casing 2 and increases towards the load opening 7.

This is due to the fact that the flow of air, as stated, enters from the load opening 7 and leaves from the discharge opening 18. Therefore, inside the cooking chamber 10, the hot air shall be transferred downwards compensating for the lower density of the radiating elements in this zone, so as to give the food product or the toast inside the cooking chamber a virtually uniform radiation on all of the surface.

The toaster also has closing or shielding elements for the load opening 7 in order to improve performance, i.e. the flow of fresh air 8 along the walls, and to avoid the passage of radiation emitted by the radiating elements 3 through it.

For example, the shielding element can be made in any way and, in the embodiment shown in the attached figures, the shielding element comprises a simple door 19 which can be opened for the introduction or removal of toast and which is closed during cooking or when the toaster is not being used so as to avoid the escape of radiation thus keeping the upper surfaces 31 even cooler during operation, and to avoid the entry of dust or dirt inside the cooking chamber when the toaster is not in use.

Clearly, in place of the door 19 any other system can be used, for example commanded by the same lever which allows the toast to fall inside the cooking chamber.

In other embodiments (not represented) the toaster does not have the shielding elements.

The speed of the radial ventilator can advantageously be varied according to the temperature reached inside the cooking chamber 10.

This allows there to be a further regulation of the temperature of the cooking chamber which, thanks also to the presence of the shielding elements, such as the door 19, can operate as a veritable small oven reaching high temperatures whilst still keeping the surfaces 31 outside of the metal casing 2 cool.

Moreover, the delivery through the discharge opening 18 of the current of air can allow the heating of croissants or other foods, or butter, placed on top of a side support 21 which can fold onto the side of the body of the toaster.

The different passages of the flow of air from the casing 2, inside the base 4, are obtained through many openings 22, arranged on the side of the crumb collection tray 23 placed centrally at the bottom of the cooking chamber 10.

Moreover, it should also be noted how the base 4 has walls 24 made from plastic which cover the walls 31 of the casing 2 in the zone in which it gets hottest due to the mixing of the two flows of air 8 and 9, thus guaranteeing the total cooling of the side walls of the metal casing.

The operation of the apparatus for cooking toast according to the finding can clearly be seen from that which has been described and illustrated.

In particular, each time one wishes to cook toast the control device shall make the ventilator 6 rotate which will create a flow of air going downwards suitable for cooling the outer walls 31 of the metal casing 2 and for being expelled with a predetermined direction, for example towards the support 21 which can thus be heated.

In practice, it has been noted how the apparatus according to the finding is particularly advantageous for having its outer walls cool, whilst still being made from metal, and for allowing the hot air used to cool down these walls to be reused.

The finding thus conceived is susceptible to numerous modifications and variants all covered by the inventive concept. Moreover, all of the details can be replaced with technically equivalent elements.

In practice, the materials used, as well as the sizes, can be whatever according to requirements and the state of the art.

1. Apparatus for cooking toast having a body with an outer casing made from metal material inside of which there is a plurality of radiating elements managed by a control device and arranged near to the cooking chamber the access to which is defined by one or more load openings in said outer casing made from metal material, characterised in that it comprises means for cooling the surfaces of said outer casing.

2. Apparatus for cooking toast according to claim 1, characterised in that said cooling means comprises at least one ventilation member suitable for generating a current of cool air which takes away heat from the metal walls.

3. Apparatus for cooking toast according to one or more of the previous claims, characterised in that said ventilation member comprises a radial ventilator housed at the bottom of said body.

4. Apparatus for cooking toast according to one or more of the previous claims, characterised in that said current of air is expelled towards the outside of said body through discharge openings.

5. Apparatus for cooking toast according to one or more of the previous claims, characterised in that said current of air has a first flow of cool air sucked from said load openings and a second flow of hot air sucked from said cooking chamber.

6. Apparatus for cooking toast according to one or more of the previous claims, characterised in that said first flow of cool air passes mainly in perimetric ducts of said casing.

7. Apparatus for cooking toast according to one or more of the previous claims, characterised in that said second flow of air passes mainly in said cooking chamber and mixes with said first flow of cool air at the bottom of said casing upstream of said radial ventilator.

8. Apparatus for cooking toast according to one or more of the previous claims, characterised in that said control device is cooled constantly by said first flow of cool air.

9. Apparatus for cooking toast according to one or more of the previous claims, characterised in that said first and second flow of air are substantially kept separate at least along the whole length of said casing.

10. Apparatus for cooking toast according to one or more of the previous claims, characterised in that said radiating elements have a power density which decreases towards the base of said casing and increases towards said load openings.

11. Apparatus for cooking toast according to one or more of the previous claims, characterised in that it comprises shielding elements for said load openings to avoid the passage of radiation emitted by said radiating elements through them.

12. Apparatus for cooking toast according to one or more of the previous claims, characterised in that it comprises at least one closing element to create a preferential route for the cool air along the side walls.

13. Apparatus for cooking toast according to one or more of the previous claims, characterised in that the speed of said radial ventilator is variable according to the temperature reached inside said cooking chamber.

14. Apparatus for cooking toast according to one or more of the previous claims, characterised in that it comprises a support arranged near to the outlet from said body of said current of air to heat one or more food product.

15. Apparatus for cooking toast according to one or more of the previous claims, characterised in that at the bottom of said casing there are openings for said current of air with the exception of a central zone where a crumb collection tray is housed.

16. Apparatus for cooking toast according to one or more of the previous claims, characterised in that the part of said body arranged at the bottom of said casing made from metal material is made from plastic material.

17. Apparatus for cooking toast according to one or more of the previous claims, characterised in that said part of said body arranged at the bottom of said casing has walls which lie over it.
